(19) United States
(12) Patent Application Publication
(10) Pub. No.: US 2009/0152973 A1
(43) Pub. Date: Jun. 18, 2009

(54) Winding Module for Motor

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/023,114

(22) Filed: Jan. 31, 2008

(30) Foreign Application Priority Data
Dec. 18, 2007 (TW) 096148438

(51) Int. Cl. H02K 3/46

(52) U.S. Cl. 310/179; 310/184; 310/198; 310/194

(57) ABSTRACT

A winding module for a motor includes at least one support and a plurality of windings positioned on and supported by the support. The windings are electrically connected to each other and include a plurality of wire connections. A packaging body encloses the support and the windings. The packaging body includes a mounting hole for receiving an axle tube of a motor. A plurality of electrical connection members are respectively coupled with the wire connections. Each electrical connection member is partially exposed outside the packaging body.

### BACKGROUND OF THE INVENTION

1. Field of the Invention

The present invention relates to a winding module for a motor and, more particularly, to a winding module including a mounting hole allowing the winding module to be rapidly mounted on an axle tube of a motor.

2. Description of Related Art

A typical motor, as illustrated in FIG. 1, generally includes a rotor 91, at least one winding 92, and a driving circuit board 93. The windings 92 are mounted on and electrically connected to the driving circuit board 93. The windings 92 and the driving circuit board 93 are mounted to an axle tube 94 to which the rotor 91 is coupled. Driving current provided by the driving circuit board 93 is supplied to the windings for energizing the windings 92, so as to create a magnetic field for driving the rotor 91 to rotate by repulsive force.

The windings 92 are generally connected to the driving circuit board 93 by soldering. However, the wires forming the windings 92 for a small-size motor have a relatively small diameter such that the wires are liable to break during soldering, leading to an increase in the costs, for the windings 92 must be replaced, and replacement of the windings 92 involves troublesome winding of the windings 92 and mounting of the windings 92 on desired locations on the driving circuit board 93, adding difficulties to manufacturing of the motor.

As has been discussed above, a need exists for a winding module that can be rapidly and easily mounted on an axle tube of a motor.

### SUMMARY OF THE INVENTION

An object of the present invention is to provide a winding module that allows convenient, rapid assembly of motors and that increases the yield rate of motors.

A winding module for a motor according to the preferred teachings of the present invention includes at least one support and a plurality of windings positioned on and supported by the at least one support. The windings are electrically connected to each other and include a plurality of wire connections. A packaging body encloses the at least one support and the windings. The packaging body includes a mounting hole adapted for receiving an axle tube of a motor. A plurality of electrical connection members are respectively coupled with the wire connections. Each electrical connection member is partially exposed outside the packaging body.

In a preferred embodiment, the winding module includes a plurality of supports on which the windings are respectively positioned and supported.

Preferably, each electrical connection member includes an inner connecting portion in the packaging body and electrically connected to one of the wire connections. Each electrical connection member further includes an outer connecting portion outside the packaging body.

Preferably, the mounting hole is in a center of the winding module and surrounded by the windings. Preferably, the packaging body includes opposite first and second sides, and the mounting hole extends from the first side through the second side of the packaging body.

Other objects, advantages and novel features of this invention will become more apparent from the following detailed description when taken in conjunction with the accompanying drawings.

### BRIEF DESCRIPTION OF THE DRAWINGS

FIG. 1 shows an exploded perspective view of a conventional motor.

FIG. 2 shows a perspective view of a winding module of a first embodiment according to the preferred teachings of the present invention.

FIG. 3 shows a cross-sectional view of the winding module of FIG. 2.

FIG. 4 shows an exploded perspective view of an axial gap type motor utilizing the winding module of FIG. 2.

FIG. 5 shows an exploded perspective view of an axial gap type motor utilizing a winding module for a motor of a second embodiment according to the preferred teachings of the present invention.

FIG. 6 shows an exploded perspective view of an axial gap type motor utilizing a winding module for a motor of a third embodiment according to the preferred teachings of the present invention.

FIG. 7 shows an exploded perspective view of a radial gap type motor utilizing a winding module for a motor of a fourth embodiment according to the preferred teachings of the present invention.

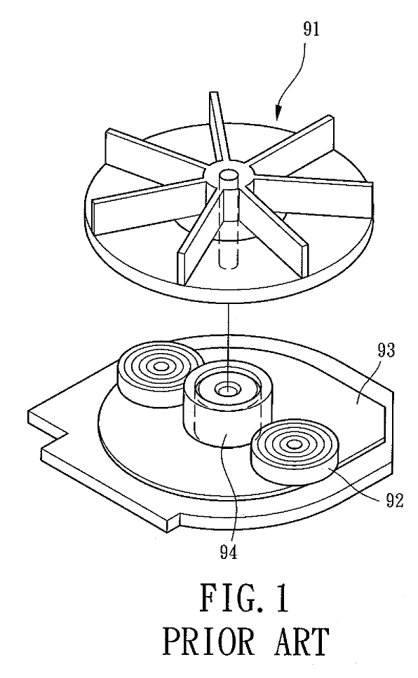

### DETAILED DESCRIPTION OF THE PREFERRED EMBODIMENTS

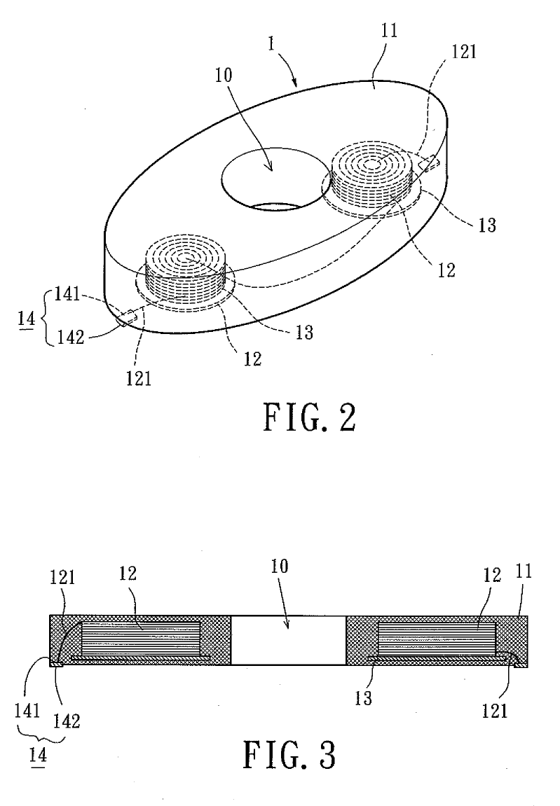

A winding module 1 for a motor of a first embodiment according to the preferred teachings of the present invention is shown in FIGS. 2 and 3. The winding module 1 includes two windings 12, two supports 13 on which the windings 12 are respectively positioned and supported, a packaging body 11, and a pair of electrical connection members 14. Each support 13 can be a non-metal plate or a metal plate. The supports 13 and the windings 12 are packaged by the packaging body 11 made of a non-magnetically conductive, non-electrically conductive material such as a packaging gel made of epoxy resin, providing a modularized motor winding. The packaging body 11 is in the form of an ellipsoid, and includes a mounting hole 10 in the form shown as a central, through-hole extending from a side through the other side of the packaging body 11 and located between and spaced from the windings 12. The whole winding module 1 is also in the form of an ellipsoid. Other shapes of the packaging body 11 and the winding module 1 would be within the skill of the art. The windings 12 are electrically connected to form a single-phase, two-wire type motor winding having two wire connections 121 for respective electrical connection with the electrical connection members 14. As can be seen from FIGS. 2 and 3, the windings 12 are enclosed in the packaging body 11 and, thus, not exposed, avoiding damage to the insulating paint covering the windings 12 and, thus, avoiding short-circuit of the windings 12. Furthermore, the windings 12 are isolated from ambient air, avoiding aging of the windings 12 resulting from oxidization and assuring reliable electrical connection. Furthermore, the supports 13 provide enhanced positioning effect and enhanced supporting effect for the windings 12.

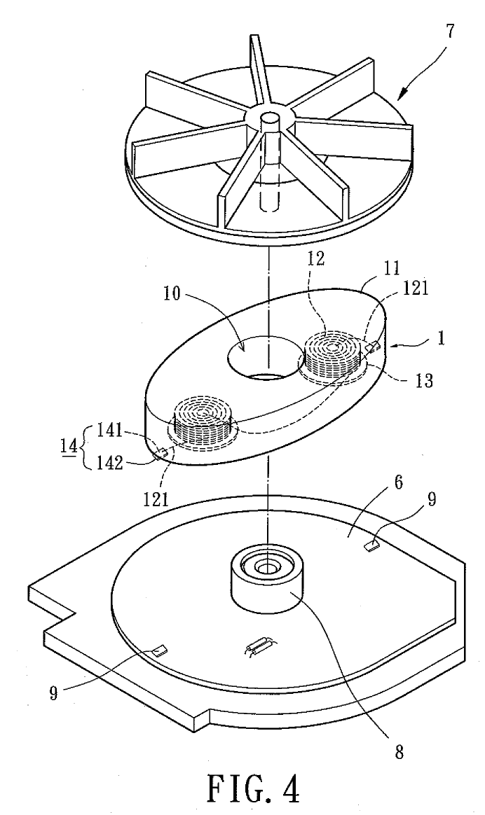

Referring to FIGS. 2 through 4 now, according to the preferred form shown, the electrical connection members 14 are made of an electrically conductive material and respectively, electrically coupled with the wire connections 121 of the windings 12 and partially exposed outside the packaging body 11. Specifically, as can be seen from FIG. 3, each electrical connection member 14 includes an inner connecting portion 141 in the packaging body 11 and electrically connected to one of the wire connections 121. Each electrical connection member 14 further includes an outer connecting portion 142 outside the packaging body 11 for electrical connection with one of two contacts 9 of a driving circuit board 6 of a motor as shown in FIG. 4. Current can be fed to the windings 12 through the outer connecting portions 142 of the electrical connection members 14 to energize the windings 12 for creating a magnetic field. A test can be carried out on the winding module 1 to find out the positive and negative poles of the winding module 1. Marks indicating the positive and negative poles of the winding module 1 can be provided adjacent to the outer connecting portions 142 for easy identification by a worker when proceeding with electrical connection with the driving circuit board 6.

In assembly, the winding module 10 is mounted around an axle tube 8 of the motor, with the mounting hole 10 receiving the axle tube 8. A rotor 7 is coupled with the axle tube 8. The outer connecting portions 142 of the electrical connection members 14 of the winding module 1 are coupled with the contacts 9 of the driving circuit board 6 for energizing the windings 12 when a current goes through the windings 12, so as to create an axial magnetic field for driving the rotor 7 to rotate.

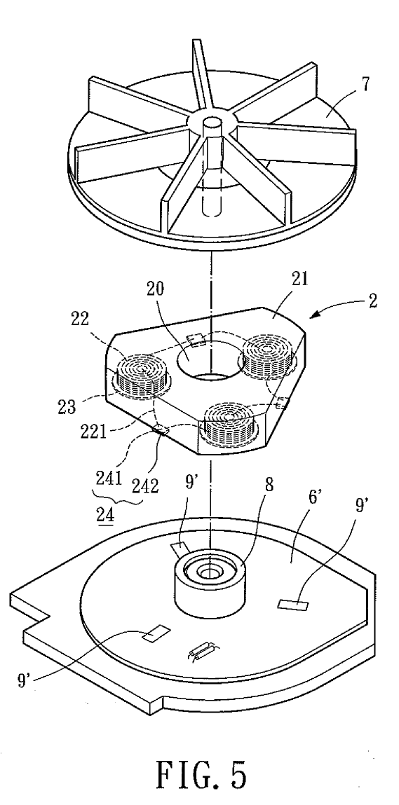

FIG. 5 shows an exploded perspective view of an axial gap type motor utilizing a winding module 2 for a motor of a second embodiment according to the preferred teachings of the present invention. The winding module 2 of the second embodiment includes three windings 22 and three supports 23 on which the windings 22 are respectively positioned and supported, and each of the windings 22 provides two wire connections 221. Furthermore, the winding module 2 includes a plurality of electrical connection members 24, and each electrical connection member 24 has an inner connecting portion 241 in the packaging body 21 for at least one said wire connections 221 to electrically connect and an outer connecting portion 242 outside the packaging body 21 for electrical connection with one of three contacts 9′ of a driving circuit board 6′ of the motor. The packaging body 21 is in the form of a triangular prism and includes a mounting hole 20 extending from a side through the other side of the packaging body 21 and located in a center of the packaging body 21, with the windings 22 surrounding the mounting hole 20 and annularly spaced from one another at regular intervals. Other shapes of the packaging body 21 and the winding module 2 would be within the skill of the art.

It can be appreciated that other connections of the windings 22 are possible to form a single-phase, two-wire type motor winding or a three-phase, four-wire type motor winding. For example, when the windings 22 forms a three-phase, three-wire type motor winding as shown in FIG. 5, each the connection member 24 connects to two wire connections 221 belonging to two adjacent windings 22 respectively; that is, the wire connections 221 connect to the connection members 24 in a manner to form a delta-connection. However, when the windings 22 forms a three-phase, four-wire type motor winding, the number of the connection members 24 is four and the wire connections 221 connect to the connection members 24 in a manner to form a Y-connection, so as to correspond to the type of motor winding.

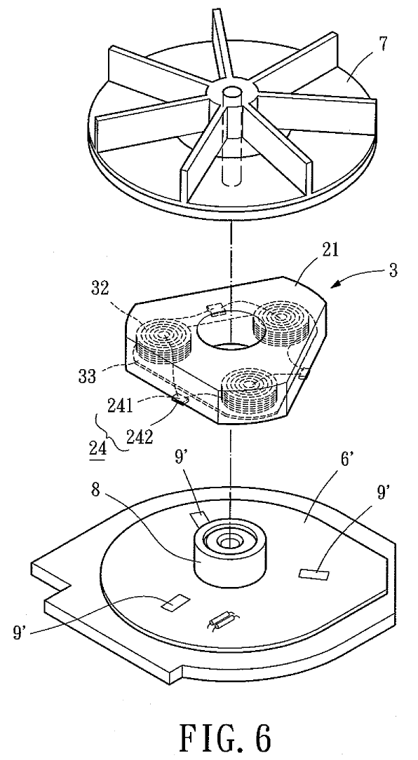

FIG. 6 shows an exploded perspective view of a radial gap type motor utilizing a winding module 3 for a motor of a third embodiment according to the preferred teachings of the present invention. The only difference between the second embodiment and the third embodiment is that the winding module 3 of the third embodiment includes a common support 33 on which the three windings (now designated by 32) are mounted. The support 33 can be made of a magnetically conductive material and can be in the form of an iron yoke plate to enhance the rotating efficiency of the motor.

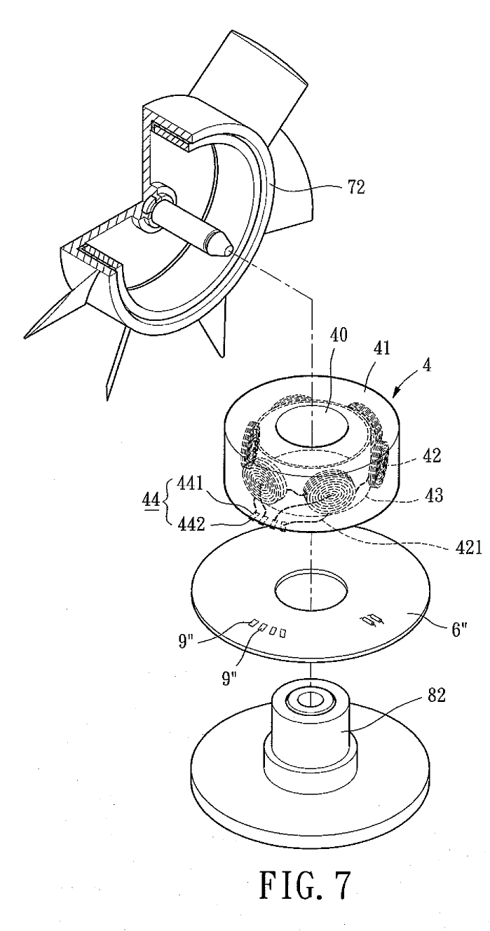

FIG. 7 shows an exploded perspective view of an axial gap type motor utilizing a winding module 4 for a motor of a fourth embodiment according to the preferred teachings of the present invention. The winding module 4 includes six windings 42 and an annular support 43 on which the windings 42 are mounted, and each of the windings 42 provides two wire connections 421. Furthermore, the winding module 4 includes four electrical connection members 44 each having an inner connecting portion 441 in the packaging body 41 and electrically connected to at least one of the wire connections 421. Each electrical connection member 44 further includes an outer connecting portion 442 outside the packaging body 41 for electrical connection with one of four contacts 9″ of a driving circuit board 6″ mounted around an axle tube 82 of the motor. In detail, the windings 42 forms a three-phase, four-wire type motor winding, with the wire connections 421 connecting to the connection members 44 in a manner to form a Y-connection.

The packaging body 41 is in the form of a hollow cylinder and includes a mounting hole 40 extending from a side through the other side of the packaging body 41 and located in a center of the packaging body 41, with the annular support 43 surrounding the mounting hole 40, and with the windings 42 surrounding the mounting hole 40 and annularly spaced from one another at regular intervals. Thus, the whole winding module 4 is also in the form of a hollow cylinder. Other shapes of the packaging body 41 and the winding module 4 would be within the skill of the art. The winding module 4 is mounted around the axle tube 82 to which a rotor 72 is mounted. It can be appreciated that other connections of the windings 42 are possible to form a single-phase/two-wire type motor winding or a three-phase/three-wire type motor winding.

The winding module 1, 2, 3, 4 according to the preferred teaching of the present invention can be easily and rapidly coupled with the axle tube 8, 82 of the motor. Furthermore, the packaging body 11, 21, 41 seals the windings 12, 22, 32, 42 and the support(s) 13, 23, 33, 43 to avoid exposure of the windings 12, 22, 32, 42. Assembling convenience of motors is enhanced, and the yield rate of the motors is increased.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A winding module for a motor comprising:
at least one support;
a plurality of windings positioned on and supported by said at least one support, with the plurality of windings being electrically connected to each other and including a plurality of wire connections;
a packaging body enclosing said at least one support and the plurality of windings, with the packaging body including a mounting hole adapted for receiving an axle tube of a motor; and
a plurality of electrical connection members respectively coupled with the plurality of wire connections, with each of the plurality of electrical connection members being partially exposed outside the packaging body.

2. The winding module for a motor as claimed in claim 1, with said at least one support including two supports, with the plurality of windings including two windings respectively positioned on and supported by the two supports.

3. The winding module for a motor as claimed in claim 1, with said at least one support including a plurality of supports on which the plurality of windings are respectively positioned and supported.

4. The winding module for a motor as claimed in claim 1, with each of the plurality of electrical connection members including an inner connecting portion in the packaging body and electrically connected to one of the plurality of wire connections, and with each of the plurality of electrical connection members further including an outer connecting portion outside the packaging body.

5. The winding module for a motor as claimed in claim 1, with the winding module being one of an ellipsoid, a triangular prism, and a hollow cylinder.

6. The winding module for a motor as claimed in claim 1, with the mounting hole being in a center of the winding module, and with the plurality of windings surrounding the mounting hole.

7. The winding module for a motor as claimed in claim 1, with the packaging body including opposite first and second sides, and with the mounting hole extending from the first side through the second side of the packaging body.

8. The winding module for a motor as claimed in claim 7, with the plurality of windings surrounding the mounting hole and angularly spaced from each other at regular intervals.

9. The winding module for a motor as claimed in claim 8, with said at least one support including an annular support surrounding the mounting hole, and with the plurality of windings being mounted on the annular support.
